(19) United States
(12) Patent Application Publication
(10) Pub. No.: US 2009/0248955 A1
(43) Pub. Date: Oct. 1, 2009

(54) REDUNDANCY FOR CODE IN ROM

(76) Inventor: Satoru Tamada, Kamakura (JP)

Correspondence Address: COOL PATENT, P.C.;c/o CPA Global, P.O. BOX 52050, MINNEAPOLIS, MN, 55402, US

(21) Appl. No.: 12/059,332

(22) Filed: Mar. 31, 2008

(51) Int. Cl. G06F 12/00

(52) U.S. Cl. 711/102; 711/E12.001

(57) ABSTRACT

A memory device capable of replacing code in read-only memory (ROM) by using a ROM redundancy register is disclosed. The memory device includes a controller that accesses code in ROM by use of a ROM address. The memory device further includes a ROM redundancy register capable of storing one or more ROM addresses and storing code corresponding to the one or more ROM addresses. The one or more ROM addresses may represent address locations in ROM that need code replacement. The ROM redundancy register may determine whether code corresponding to the ROM address should be replaced by code stored in the ROM redundancy register.

### BACKGROUND

Code in read-only memory (ROM) is hardwired into non-volatile memory during production, therefore making it difficult to replace. By design, a memory controller can access the boot code in ROM to obtain data for initialization and operation of a memory device, but otherwise is prevented from altering the boot code. However, there may be instances where a user may want to change the boot code. For example, during a testing process, the user may want to modify the code, such as adjusting a wait time to account for the parasitic RC delay in charging a bit line. Currently, the user can only do this by performing a focused ion beam experiment or mask change. These methods may take days to perform, and can cause additional delay and expense.

Another way to replace code in ROM is by having the controller directly access code stored in the memory array instead of code stored in ROM. However, particularly in a NAND string, this is a very slow process which can take upwards of 10 μs while the controller can typically access code at less than 100 ns. Therefore, there is a gap of greater than 100 times in accessing speed and is an inefficient process.

### BRIEF DESCRIPTION OF THE DRAWINGS

The invention will be understood more fully from the detailed description given below and from the accompanying drawings of embodiments of the invention which, however, should not be taken to limit the invention to the specific embodiment(s) described, but are for explanation and understanding only.

FIG. 1 is a block diagram of a memory device according to one embodiment.

FIG. 2 is a block diagram of an instruction ROM and a ROM redundancy register according to one embodiment.

FIG. 3 is a block diagram of a macro ROM and a ROM redundancy register according to one embodiment.

FIG. 4 is a flowchart of a method according to one embodiment.

### DETAILED DESCRIPTION

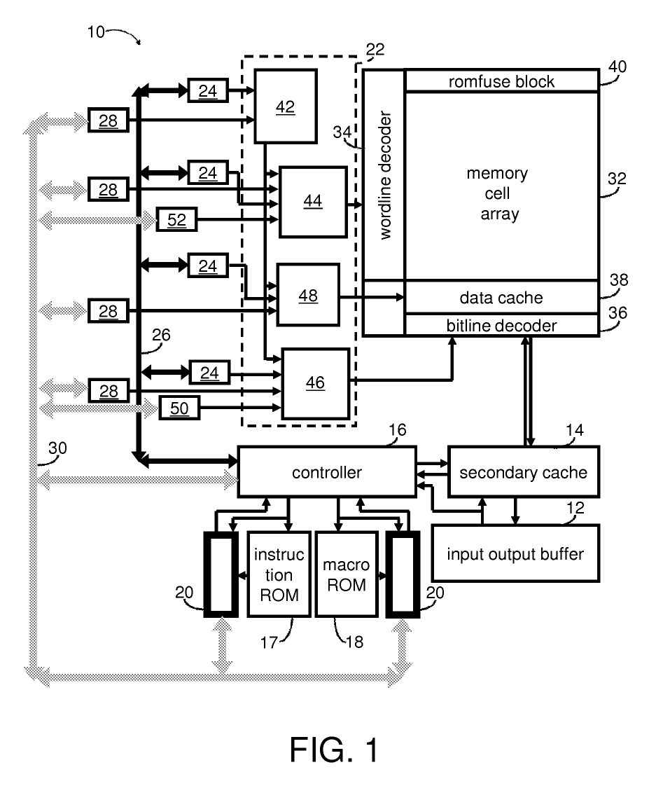

Referring to FIG. 1, a block diagram of a memory device according to one embodiment is shown at 10. The memory device may be programmed with data, read to retrieve data, and erased to clear the memory device. Memory device 10 may include an input/output (I/O) buffer 12, a secondary cache 14, a controller 16, a read-only memory (ROM) 17 and a ROM 18, and one or more ROM redundancy registers 20. Memory device 10 may further include peripheral circuits 22, control registers 24, control register bus 26, parameter registers 28, redundancy and parameter register bus 30, memory cell array 32, wordline decoder 34, and bitline decoder 36. The memory cell array 32 may include a data cache 38 and a romfuse block 40. Other embodiments of the memory device 10 may include other memory components or omit some of those illustrated in FIG. 1.

It should be understood that memory device 10 may include non-volatile random access memory (NVRAM), ferroelectric random access memory (FeRAM or FRAM), ferromagnetic random access memory (FM-RAM), magnetoresistive random access memory (MRAM), phase-change memory (PCM), read-only memory (ROM), programmable read-only memory (PROM), erasable programmable read-only memory (EPROM), electrically erasable programmable read-only memory (EEPROM), flash memory (for ex., flash NOR, flash EPROM), and other non-volatile memory. Further, memory device 10 may be formed and manufactured using MOS (metal oxide semiconductor) technology, CMOS (complementary MOS) technology, BiCMOS (bipolar CMOS) technology, or other semiconductor manufacturing technologies suitable for forming non-volatile memory.

Memory device 10 may include an I/O buffer 12 configured to receive input and output and act as an external interface. The I/O buffer 12 may hold inputted commands for controlling the memory device 10, address information, data to be entered into the memory cell array 32, and data retrieved from the memory cell array 32. The I/O buffer 12 may send data to the secondary cache 14 for temporary storage and on to other components in the memory device 10.

The secondary cache 14 may be configured to receive data from I/O buffer 12 and from memory cell array 32. The controller 16 may be capable of reading any data that is loaded into the secondary cache 14.

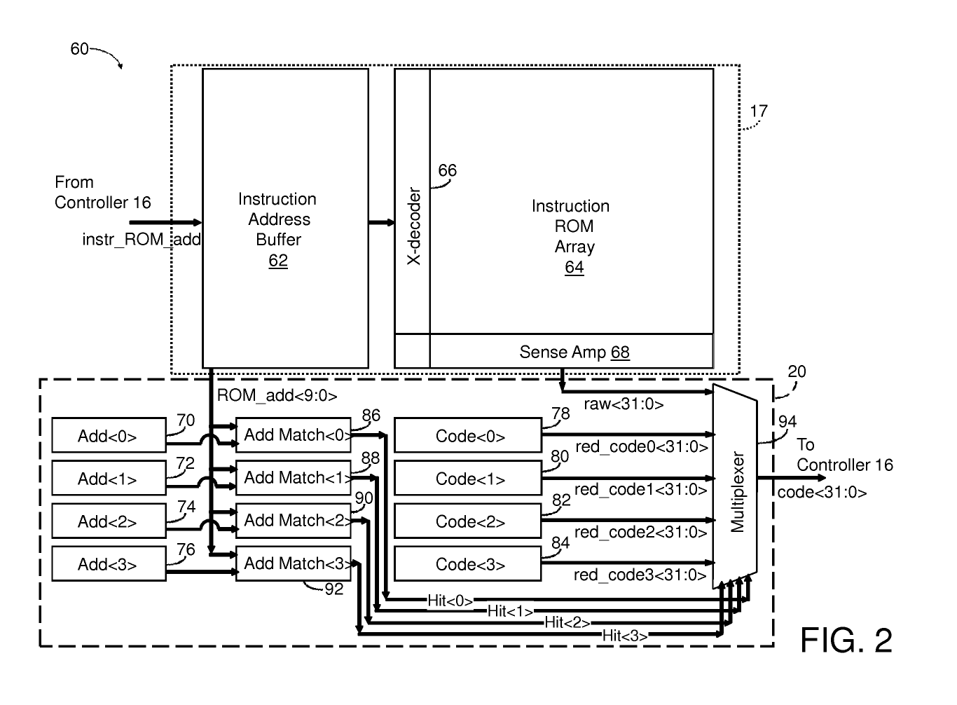

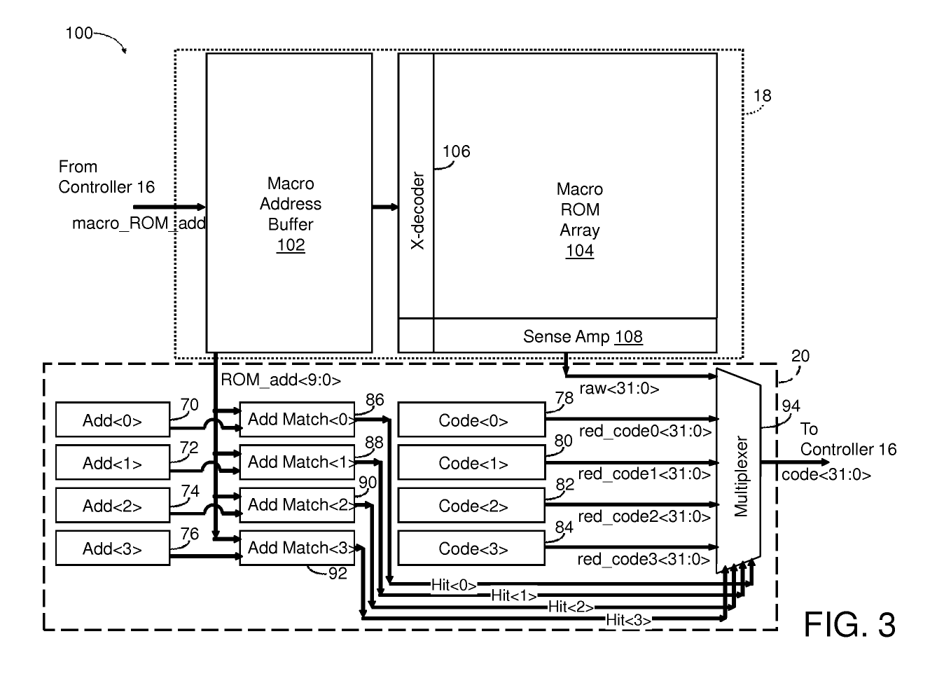

The controller 16 may be responsible for programming and erasing of the memory cell array 32. The controller 16 may be capable of sending a ROM address to a ROM 17 and/or 18 to access code, which may include instruction code and macro code. In one embodiment, memory device 10 may include an instruction ROM 17 and a macro ROM 18. The controller 16 may further access code from one or more ROM redundancy registers 20 capable of storing code as a replacement for code that is stored in ROM 17 and/or ROM 18, as further described in FIGS. 2 and 3 below.

The controller 16 may also be capable of controlling other components of memory device 10 for normal read, write, and erase operations. The controller 16 may include a state machine for dedicated reading, erasing, and/or programming operations of the memory device 10.

The controller 16 may be further capable of controlling the peripheral circuits 22 by providing values to one or more control registers 24 via control register bus 26 and values to one or more parameter registers 28 via redundancy and parameter register bus 30. Peripheral circuits may include charge pumps and regulators 42, block address control and block redundancy circuit 44, column address control and column redundancy circuit 46, and data cache driver 48. The controller 16 may use the control register bus 26 to send controls signals to one or more control registers 24 controlling the charge pumps and regulators 42, block address control and block redundancy circuit 44, column address control and column redundancy circuit 46, and data cache driver 48. For example, control signals may include enable or disable, high or low, etc. The controller 16 may use the redundancy and parameter register bus 30 to send parameter values to one or more parameter registers 28 regulating the charge pumps and regulators 42, block address control and block redundancy circuit 44, column address control and column redundancy circuit 46, and data cache driver 48. For example, parameter values may include voltages sent to the charge pumps and regulators 42, other configurations, etc.

Although represented as single blocks of control registers 24 and parameter registers 28, there may be multiple control registers 24 and parameter registers 28 for controlling one or more of the peripheral circuits 22. It should be noted that peripheral circuits 22 may include additional circuits, such as clocking circuits, or omit some of those illustrated in FIG. 1. It should be further noted that for simplicity, one or more of the peripheral circuits may include separate functions that are grouped together in one block. The scope of the claimed subject matter is not limited in these respects.

To sustain dynamic or static loads during different operating conditions to the memory cell array 32, the charge pumps and regulators 42 may be configured to provide bias voltages to one or more components which may include block address control and block redundancy circuit 44, column address control and column redundancy circuit 46, and data cache driver 48. The charge pumps and regulators 42 may also provide voltages to the wordline decoder 34, the bitline decoder 36, the data cache 38, and other memory components that may require regulated voltages.

The block address control and block redundancy circuit 44 is capable of comparing a block address that is received from the controller 16 to block addresses that are stored in a block redundancy register 44 to determine whether the block address corresponds to a problem location in the memory cell array 32. If the block address control and block redundancy circuit 44 finds a match, block address control 44 disables normal decoding of the memory cell array 32 and activates decoding of block redundancy to retrieve data from a new memory location on memory cell array 32. Similarly, the column address control and column redundancy circuit 46 is capable of comparing a column address that is received from the controller 16 to column addresses that are stored in a column redundancy register to determine whether the column address corresponds to a problem location in the memory cell array 32. If the column address control and column redundancy circuit 46 finds a match, column address control 46 disables normal decoding of the memory cell array 32 and activates decoding of column redundancy to retrieve data from a new memory location on memory cell array 32. Peripheral circuits 22 further include a data cache driver 48 configured to control when and/or how data may be moved in and out of the data cache 38.

Memory cell array 32 includes a plurality of memory cells arranged in an ordered array of rows and columns. The memory cells are independently addressable and may be programmed and read. In response to a received address from the block address control and block redundancy circuit 44, the wordline decoder 34 selects one or more rows (blocks) of the memory cell array for access to data. Similarly, upon receipt of an address from the column address control and column redundancy circuit 46, the bitline decoder 36 selects one or more columns of the memory cell array 32 for access to data.

Memory cell array 32 includes data cache 38 which is capable of reading blocks of data by accessing pages from the memory cell array 32 and storing user input from the secondary cache 14. Data cache 38 may store data immediately prior to programming or immediately after reading from the memory cell array 32. Data cache 38 may include sense amplifiers and latches to sense and hold data.

Memory cell array 32 may include a romfuse block 40 which is write-inhibited after first programming. For example, programming may occur during fabrication of memory device 10 or during user customization such as by blowing selected fuses on the silicon substrate. During the booting process of the memory device 10, the romfuse block 40 may be accessed first for initialization.

According to one embodiment, during a chip initialization sequence of the memory device 10, data transfer occurs from a first page (page0) of the romfuse block 40 to the data cache 38 using a default parameter value. The controller 16 reads the data from data cache 38 via secondary cache 14 and relocates the data into a column redundancy register 50. A column redundancy scheme, as described above, is initialized. Data is transferred from a second page (page1) of romfuse block 40 to data cache 38 with a default parameter value. The controller 16 reads data from data cache 38 via secondary cache 14 and relocates the data into one or more parameter registers 28. The loaded parameter values may then be used. The controller 16 reads data from data cache 38 and relocates the data into a block redundancy register 52. A block redundancy scheme, as described above, is initialized. The controller 16 reads data from data cache 38 via secondary cache 14 and relocates the data into one or more ROM redundancy registers 20. A redundancy for code scheme, as described below, is initialized.

The chip initialization sequence of memory device 10 may be controlled by code stored in ROM 17 and/or 18. However, after data is relocated in one or more ROM redundancy registers, the code in ROM 17 and/or 18 may be replaced with redundancy code stored in one or more of the ROM redundancy registers 20, as further described below. It should be noted that the chip initialization sequence of memory device 10 may be triggered by any number of factors. For example, the chip initialization sequence may begin in response to a power on signal or user command. Further, the chip initialization sequence may differ from the order of steps as described above, but the scope of the claimed subject matter is not limited in these respects.

Referring to FIG. 2, a block diagram of an instruction ROM 17 and a ROM redundancy register 20 according to one embodiment is shown at 60. The instruction ROM 17 may include an instruction address buffer 62 coupled to an instruction ROM array 64. The instruction address buffer 62 may receive instruction ROM addresses from the controller 16 and temporarily hold the ROM addresses until the ROM addresses are sent to an X-decoder 66 and/or the ROM redundancy register 20. The instruction ROM 64 may include X-decoder 66 and sense amplifiers 68 to sense data. The X-decoder 66 may use an instruction ROM address received from the instruction address buffer 62 to retrieve code from the instruction ROM 64. The sense amplifiers 68 may take the code retrieved from the instruction ROM address and output the data to the ROM redundancy register 20. In general, instruction code may include upper-level instructions, such as providing an algorithm for the controller 16. For example, instructions may include instructions to force outputs, instructions of absolute or conditioned jump, instructions to jump to and return from subroutines, and halt instructions, although the scope of the claimed subject matter is not limited in this respect.

Referring briefly to FIG. 3, which shows a block diagram of a macro ROM 18 and a ROM redundancy register 20 according to one embodiment at 100. The ROM redundancy register 20 may behave identically or substantially similarly to the ROM redundancy register 20 of FIG. 2. Thus, the following paragraphs describing the ROM redundancy register 20 pertains to both FIGS. 2 and 3. When referring to ROM herein, in FIG. 2, ROM 17 is an instruction ROM capable of storing instruction code, whereas in FIG. 3, ROM 18 is a macro ROM capable of storing macro code, as further described below.

Referring now to FIGS. 2 and 3, ROM redundancy register 20 may include 10-bit registers 70, 72, 74, and 76 for storing ROM addresses and corresponding 32-bit registers 78, 80, 82, and 84 for storing corresponding code, respectively. Registers 70, 72, 74, 76, 78, 80, 82, and 84 may hold redundancy information loaded into the registers at the chip initialization sequence as mentioned above. The redundancy information includes one or more ROM addresses and code corresponding to the one or more ROM addresses. The ROM addresses stored in the ROM redundancy register 20 represent ROM address locations with code that need to be replaced.

For example, if code located in the ROM address is corrupted, faulty, or needs to be changed as determined by a user, the ROM address may be previously flagged or recorded. A program or user may input replacement code to replace code corresponding to the flagged ROM address. One or more addresses and corresponding replacement code may be entered into the memory cell array 32 as redundancy information, which is later stored in the ROM redundancy register 20.

In one or more embodiments, the ROM redundancy register 20 may be used to “replace” code in ROM. It should be noted that the ROM redundancy register 20 does not physically replace the code at an address location in ROM. However, when the ROM address location is accessed, the ROM redundancy register 20 may be capable of substituting code that is stored in the ROM redundancy register 20 for code that is retrieved from the address location in ROM. Therefore, the controller 16 may receive replacement code from the ROM redundancy register 20 in lieu of code from ROM.

To provide replacement code to the controller 16, the ROM redundancy register 20 may be capable of determining whether the ROM address requested from the controller 16 matches with a ROM address stored in the ROM redundancy register 20. If a matching address is found in the ROM redundancy register 20, code located at the ROM address may be replaced by code stored in the ROM redundancy register 20. The ROM redundancy register 20 may include a logic circuit for comparing addresses and determining code that is sent to the controller 16. The logic circuit may use combinatorial or sequential logic.

It should be noted that a matching address does not need to match a requested ROM address exactly. For example, an address match may be found if nine specific bits out of ten bits are identical. What is defined as matching may depend on how a user desires to implement code replacement strategies for the ROM using the ROM redundancy register 20.

In one embodiment, the ROM addresses stored in the registers 70, 72, 74, and 76 may be fed into comparators 86, 88, 90, and 92, respectively. A ROM address may be sent from controller 16 and fed into the comparators 86, 88, 90, and 92. The instruction address buffer 62 may regulate when the ROM address is sent to the comparators 86, 88, 90, and 92. A comparison may be made at the comparators to determine whether there is an address match. If an ROM address stored in a register 70, 72, 74, or 76 matches the ROM address requested from controller 16, a corresponding comparator 86, 88, 90, or 92 may output a high signal (1). If the ROM address stored in the register 70, 72, 74, or 76 does not match the ROM address from controller 16, the corresponding comparator 86, 88, 90, or 92 may output a low signal (0).

The multiplexer 94 may be capable of controlling whether code located at the ROM address or code stored in the ROM redundancy register 20 is sent to the controller 16. The output signals from the comparators 86, 88, 90, and 92 are sent to a multiplexer 94. The multiplexer 94 also receives code located at the ROM address requested by the controller 16. The multiplexer 94 further receives redundant code stored at registers 78, 80, 82, and 84 corresponding to the ROM addresses stored in registers 70, 72, 74, and 76.

If multiplexer 94 receives a high signal from one of the comparators 86, 88, 90, and 92, the multiplexer 94 may output the code stored in one of the registers 78, 80, 82, and 84, which corresponds to the received high signal. The outputted code may be sent to the controller 16, and ROM code is replaced. If multiplexer 94 does not receive a high signal from one of the comparators 86, 88, 90, and 92, the multiplexer 94 may output the code located at the ROM address. The outputted code may be sent to the controller 16, and ROM code is not replaced.

Referring now to FIG. 2, as a further illustrative example, controller 16 may send an instruction ROM address as a request for code from an instruction ROM 17. The instruction ROM address is buffered in instruction address buffer 62, and then sent to instruction ROM array 64 and to comparators 86, 88, 90 and 92. Code is retrieved from the instruction ROM array 64 using the instruction ROM address and sent to a multiplexer 94. In this example, the instruction ROM address matches with a ROM address stored in register 74 and comparator 90 outputs a high signal to multiplexer 94. The multiplexer 94 selects code stored in the register 82 corresponding to the high signal from the address match of the ROM address stored in register 74. The selected code is outputted and sent to controller 16.

Returning to FIG. 3, a macro ROM 18 is capable of storing macro code for access by the controller 16. Macro ROM 18 may include a macro address buffer 102 coupled to a macro ROM array 104. The macro address buffer 102 may receive macro ROM addresses from the controller 16 and temporarily hold the ROM addresses until the ROM addresses are sent to X-decoder 106 and/or the ROM redundancy register 20. The macro ROM 104 may include an X-decoder 106 and sense amplifiers 108 to sense data. The X-decoder 106 may use a macro ROM address received from the macro address buffer 102 to retrieve code from the macro ROM array 104. The sense amplifiers 108 may take the code retrieved from the macro ROM address location and output the code to the ROM redundancy register 20.

As depicted, the configuration and components of FIG. 3 may be substantially similar to those of FIG. 2. However, the scope of the invention is not limited in this respect. One difference between the embodiments depicted in FIGS. 2 and 3 includes the use of instruction code versus macro code in ROM. In general, macro code may be used in lower-level coding for control of peripheral circuits 22, such as turning on or off the peripheral circuits 22.

As shown in FIG. 3 and described above, the ROM redundancy register 20 behaves as the ROM redundancy register 20 depicted in FIG. 2, except instead of receiving and storing instruction ROM addresses and corresponding code, the ROM redundancy register 20 may receive and store macro ROM addresses and corresponding code. The ROM redundancy register 20 is capable of determining whether macro code requested by the controller 16 needs to be replaced and further sending the replacement code if the macro code needs to be replaced, as described in FIG. 2.

It should be noted that memory device 10 may include an instruction ROM 17 and/or a macro ROM 18, and accordingly one or more ROM redundancy registers 20, depending on how the memory device 10 is implemented. Further, if both instruction ROM 17 and corresponding ROM redundancy register 20, and macro ROM 18 and corresponding ROM redundancy register 20 were implemented together, both the instruction code and macro code may work together and/or be passed to controller 16 accordingly.

It will be appreciated that in other embodiments, a ROM 17 and/or 18 and a ROM redundancy register 20 may store code other than instruction code and macro code that is accessed by the controller 16. The sizes of the registers within the ROM redundancy register 20 may vary accordingly with the sizes of the addresses and code in ROM 17 and/or 18. The ROM redundancy register 20 may include any number of registers to hold instruction ROM addresses and code corresponding to the ROM addresses, and is not limited to the registers that are shown. The scope of the claimed subject matter is not limited in these respects.

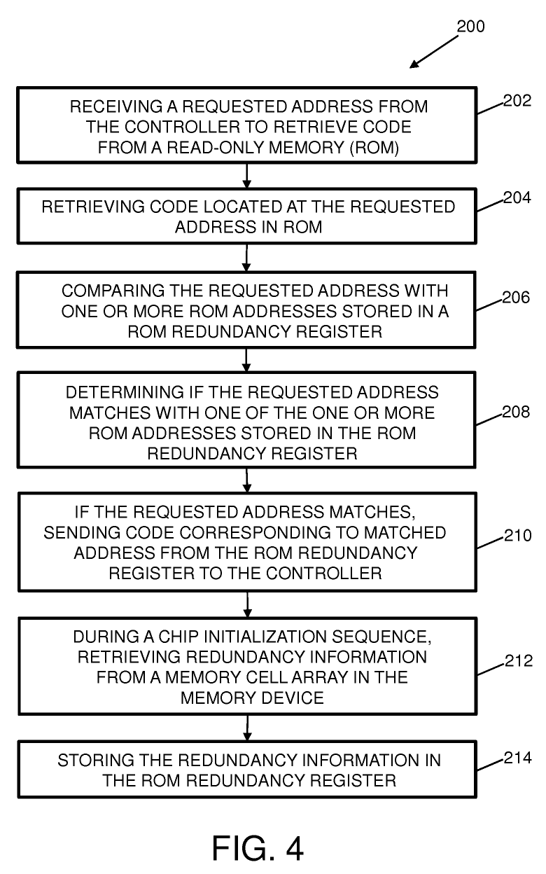

FIG. 4 is a flowchart of a method 200 of retrieving code for a controller in a memory device according to one embodiment. The method 200 includes, at 202, receiving a requested address from the controller to retrieve code from a read-only memory (ROM). At 204, the method includes retrieving code located at the requested address in ROM and at 206, comparing the requested address with one or more ROM addresses stored in a ROM redundancy register. The ROM redundancy register also stores code corresponding to the one or more ROM addresses stored in the ROM redundancy register. At 208, method 200 further includes determining if the requested address matches with one of the one or more ROM addresses stored in the ROM redundancy register. At 210, if the method determines that the requested address matches with one of the one or more addresses stored in the ROM redundancy register, method 200 further includes sending code corresponding to a matched address from the ROM redundancy register to the controller. If the method determines that the requested address does not match with one of the one or more addresses stored in the ROM redundancy register, the code retrieved from the requested address in ROM is sent to the controller.

At 212, during a chip initialization sequence of the memory device, method 200 may further include retrieving redundancy information from a memory cell array in the memory device. The redundancy information may include one or more ROM addresses and code corresponding to one or more ROM addresses. At 214, the method may further include storing the redundancy information in the ROM redundancy register. It should be noted that the method may not be presented and discussed with steps in order of occurrence, and the scope of the claimed subject matter is not limited in this respect.

It is appreciated that redundancy for code in ROM has been explained with reference to one or more embodiments, and that the invention is not limited to the specific details given above. References in the specification made to other embodiments fall within the scope of the present invention.

Any reference to device may include a component, circuit, module, or any such mechanism in which the device can achieve the purpose or description as indicated by the modifier preceding the device. However, the component, circuit, module, or any such mechanism is not necessarily a specific limitation to the device.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances of “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A memory device comprising:
a memory cell array;
one or more peripheral circuits capable of biasing the memory cell array;
a controller capable of using code to control one or more peripheral circuits;
a read-only memory (ROM) capable of storing code for access by the controller; and
a ROM redundancy register capable of storing one or more ROM addresses and storing code corresponding to the one or more ROM addresses.

2. The memory device of claim 1 wherein the controller is capable of requesting code located at a ROM address.

3. The memory device of claim 2 wherein the ROM redundancy register is capable of determining if the ROM address has a matching address stored in the ROM redundancy register.

4. The memory device of claim 3 wherein the ROM redundancy register is capable of sending code corresponding to the matching address stored in the ROM redundancy register to the controller.

5. The memory device of claim 2 wherein the ROM redundancy register comprises a logic circuit to compare the ROM address with the one or more ROM addresses stored in the ROM redundancy register.

6. The memory device of claim 5 wherein the ROM redundancy register further comprises a multiplexer capable of controlling whether code located at the ROM address or code stored in the ROM redundancy register is sent to the controller.

7. The memory device of claim 6 wherein if the ROM address has a matching address stored in the ROM redundancy register, the code stored in the ROM redundancy register corresponding to the matching address is sent to the controller.

8. The memory device of claim 1 wherein the ROM is capable of storing instruction code or macro code.

9. The memory device of claim 1 wherein the ROM redundancy register capable of storing instruction code or macro code.

10. The memory device of claim 1 wherein the ROM is capable of storing instruction code and the ROM redundancy register is capable of storing redundant code to replace instruction code in ROM, and further comprising a macro ROM capable of storing macro code, and further comprising a second ROM redundancy register capable of storing one or more macro ROM addresses and storing macro code corresponding to the one or more macro ROM addresses stored in the ROM redundancy register.

11. The memory device of claim 1 wherein the memory cell array is capable of storing redundancy information comprising one or more ROM addresses and code corresponding to the one or more ROM addresses, and further wherein the redundancy information is loaded into the ROM redundancy register during a chip initialization sequence.

12. A method of retrieving code for a controller in a memory device, the method comprising:
receiving a requested address from the controller to retrieve code from a read-only memory (ROM);
retrieving code located at the requested address in ROM;
comparing the requested address with one or more ROM addresses stored in a ROM redundancy register, the ROM redundancy register storing code corresponding to the one or more ROM address stored in the ROM redundancy register; and
determining if the requested address matches with one of the one or more ROM addresses stored in the ROM redundancy register.

13. The method of claim 12 further comprising, if the requested address matches with one of the one or more addresses stored in the ROM redundancy register, sending code corresponding to a matched address from the ROM redundancy register to the controller.

14. The method of claim 12 further comprising, during a chip initialization sequence of the memory device, retrieving redundancy information from a memory cell array in the memory device, wherein the redundancy information comprises one or more ROM addresses and code corresponding to one or more ROM addresses.

15. The method of claim 14 further comprising storing the redundancy information in the ROM redundancy register.
